(19) United States
(12) Patent Application Publication
(10) Pub. No.: US 2022/0289264 A1
(43) Pub. Date: Sep. 15, 2022

(54) Shopping Cart Handle Cover

(71) Applicant: George J. Partsch, IV, Anaheim, CA (US)

(72) Inventor: George J. Partsch, IV, Anaheim, CA (US)

(21) Appl. No.: 17/692,079

(22) Filed: Mar. 10, 2022

Related U.S. Application Data
(60) Provisional application No. 63/158,904, filed on Mar. 10, 2021.
(60) Provisional application No. 63/251,049, filed on Oct. 1, 2021.

(51) Int. Cl. B62B 5/06

(52) U.S. Cl. CPC B62B 5/069

(57) ABSTRACT

A reusable universal shopping cart handle cover having an elongated body capped on both terminal ends with collars. There is a slit that runs from one collar through the elongated body and to the other collars, making one long slit to receive a shopping cart handle. The collar has an open notch and a flared out slit opening to allow easy insertion of a shopping cart handle. The collar has grasping tabs so a user may manually force the collar slit to open.

### CROSS-REFERENCE TO RELATED APPLICATIONS

This application claims priority to, and is a non-provisional patent application of, U.S. provisional patent application No. 29/773,503, filed on Mar. 10, 2021, now pending, which is hereby incorporated by reference in its entirety.

This application also claims priority to, and is a non-provisional patent application of, U.S. provisional patent application No. 63/251,049, filed on Oct. 1, 2021, now pending, which is hereby incorporated by reference in its entirety.

Although incorporated by reference in its entirety, no arguments or disclaimers made in the provisional applications apply to this application. Any disclaimer that may have occurred in the above-referenced application is hereby expressly rescinded.

### FIELD OF THE DISCLOSURE

The present disclosure relates to a reusable handle cover to sanitation purposes, more particularly, a reusable universal handle cover for shopping cart handles, door handles, and the likes.

### BACKGROUND OF THE DISCLOSURE

Each day millions of people shop at stores for goods and groceries, and shopping carts are used to help carry their items. Generally, people cough, sneeze, touch their faces, touch their hair, touch their eyes, and scratch their skin. Many people don't wash their hands often, and some people don't shower or bathe regularly. Germs such as bacteria and viruses can easily be transferred to the shopping cart handles from the people that use them, and these public handles can be a host for harvesting and spreading germs.

Some people disinfect their shopping cart handles using wet wipes that are saturated in alcohol. Most wet wipes don't break down like tissue paper and are bad for the environment. They end up in landfills across the globe and even in our oceans. Other people use hand sanitizers to clean their skin after touching public handles. Hand Sanitizers are mostly alcohol, which can dry out their skin, and hand sanitizer containers end up in landfills. Recently, there were many brands of hand sanitizers that were found to carry carcinogens which could be dangerous to the user. Additionally, if the skin becomes cracked, dry, and open, it will make the user more susceptible to germs since skin is the protective layer that protects our bodies from foreign invaders like bacteria and viruses.

There is a continuing need for new ways to provide a sanitary way for consumer to use public shopping carts.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned needs. Although the present embodiments may obviate one or more of the above-mentioned needs, it should be understood that some aspects of the embodiments might not necessarily obviate them.

### BRIEF SUMMARY OF THE DISCLOSURE

In a general implementation, a reusable universal shopping cart handle cover includes an elongated body having a body slit opening disposed thereon. The body slit opening is disposed in a longitudinal direction along the entire length of the elongated body. This reusable shopping cart handle cover is environmentally friendly, easy to use (easily attaches and detaches to shopping cart handles) and helps protect its users from germs on shopping cart handles. It can eliminate any contact with the germs on shopping cart handles during installing and detaching. Furthermore, the germs transferred on to the contemplated shopping cart handle cover is not easily transferred to the user when carrying and transporting the shopping cart handle cover.

In another aspect combinable with the general implementation, there can be a first collar directly connected to a first terminal end of the elongated body, and a second collar directly connected on a second terminal end of the elongated body.

In another aspect combinable with the general implementation, said first and second collars each has a disc shape. These collars can be angled anywhere from 45 to 90 degrees from the elongated body of the handle cover.

In another aspect combinable with the general implementation, the first and second collars each can have a collar rim, and each of the collar rims can have an outer diameter larger than a diameter of the elongated body.

In another aspect combinable with the general implementation, the first and second collars each can have a collar slit directly connected to the body slit, making them one long slit that opens to receive a shopping cart handle.

In another aspect combinable with the general implementation, the body slit is disposed through the entire thickness of the wall;

In another aspect combinable with the general implementation, the elongated body can have a hollow interior having a center bore through the entire length of the elongated body, and the center bore is surrounded by a wall of the elongated body.

In another aspect combinable with the general implementation, the wall of the elongated body can have a circular cross-sectional shape either through its entire length or only sections of the elongated body, such as the mid-section.

In another aspect combinable with the general implementation, the first and second collar each has a center opening directly connected to the center bore, thereby providing a through bore that spans the entire length of the handle cover.

In another aspect combinable with the general implementation, the collar slit of the first and second collars can be a thin, narrow gap of equal width.

In another aspect combinable with the general implementation, the collar slit of the first and second collars and second collars can have a gap having a width that varies. The gap width closer to the center opening can be narrower than the gap width near the collar rim.

In another aspect combinable with the general implementation, there can be an open notch on the first and second collars. These open notches can each have a notch width. The open notch is disposed on the collars opposite to the collar slit, and the notch width closer to the center opening can be narrower than the notch width near the collar rim.

In another aspect combinable with the general implementation, the open notch has a pie shape.

In another aspect combinable with the general implementation, the terminal ends of the body can have a teardrop cross-sectional shape that is globular on one end and tapers to a point on an opposite end.

In another aspect combinable with the general implementation, the mid-section of the body can have a circular cross-sectional shape while the two terminal ends each has a teardrop shape.

In another aspect combinable with the general implementation, there can be grasping tabs disposed on either side of the open notch and these grasping tabs can protrude from the rim of the collars and away from a plane of the respective collars in angle perpendicular to the plane of the collars.

In another aspect combinable with the general implementation, there can be a pair of receiving slopes disposed on the collars on opposite side of the collar slit approximate to the center opening. These receiving slopes provide a receiving structure to ease the installation and removal of the handle cover to and from the shopping cart handle.

In another aspect combinable with the general implementation, there can be at least a pair of fins disposed on the elongated body. Such pair of fins are disposed on opposite sides of the body slit allowing a user to press the handlebar in between the pair of fins to open the body slit apart. Each fin can have a plane perpendicular to the longitudinal axis of the elongated body.

In another aspect combinable with the general implementation, there can be a pair of fins disposed along the entire length of the body and disposed on opposite sides of the body slit. These fins protrude from the body and can provide structure integrity to the body slit and to the collar to allow proper placement of the handle cover as a user pushes the body slit and the collar slit over the shopping cart handle.

In another aspect combinable with the general implementation, there can be provided a cutting line transversely disposed on the body to guide a user to cut the elongated body in half to create two separate and shorter pieces of handle cover

In another aspect combinable with the general implementation, the body of the handle cover can have varied outer diameter. In one embodiment, the diameter of the terminal ends can be smaller than a diameter of the mid-section of the elongated body.

In another aspect combinable with the general implementation, there can be a through hole the collars allowing attachment of a strap or rope thereto. The strap or rope allows a user to wear the handle cover across his or her chest/back.

In another aspect combinable with the general implementation, there can be a circular cut out on the collar slit of the collars to act as a catch to hold the strap and rope while the handle cover is installed onto the shopping cart handle. In this way, the strap/rope stays tucked away.

The reusable handle cover as recited in claim 12 further comprising a receiver disposed on at least one of said first and second collars; said receiver is adapted to receive an accessory.

The reusable handle cover as recited in claim 1 further comprising a pair of finger tabs disposed on the body wherein pressing the pair of finger tabs towards each other causes the body slit to open.

Accordingly, the present disclosure is directed to shopping cart handle cover or a door handle cover that can entirely or partially surround a handlebar to provide a sanitary barrier between a user's hands and the handlebar. The user can easily remove the handlebar cover from the handlebar at the end of use. This handle cover can be repeatedly used, cleaned, and is portable. This disclosure of the contemplated handle cover substantially obviates one or more problems due to limitations and disadvantages of the related art.

While this specification contains many specific implementation details, these should not be construed as limitations on the scope of any inventions or of what may be claimed, but rather as descriptions of features specific to particular implementations of particular inventions.

Certain features that are described in this specification in the context of separate implementations can also be implemented in combination in a single implementation. Conversely, various features that are described in the context of a single implementation can also be implemented in multiple implementations separately or in any suitable subcombination.

Moreover, although features may be described above and below as acting in certain combinations and even initially claimed as such, one or more features from a disclosed combination can in some cases be excised from the combination, and the claimed combination may be directed to a subcombination or variation of a subcombination.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of an embodiment of a shopping cart handle cover according to an aspect of the disclosure.

FIG. 2 is a front view of the shopping cart handle cover of FIG. 1, according to an aspect of the disclosure.

FIG. 3 is a left side view of the shopping cart handle cover of FIG. 1, according to an aspect of the disclosure. The right-side view and the rear side view being a mirror image thereof.

FIG. 4 is a cross-sectional view a body of the shopping cart handle cover along line A-A of FIG. 3, according to an aspect of the disclosure.

FIG. 5 is a top view of the shopping cart handle cover showing the collar, according to an aspect of the disclosure.

FIG. 6 is a perspective view of another embodiment of the shopping cart handle cover having a variation of design on the collars, according to an aspect of the disclosure.

FIG. 7 is a perspective view of yet another embodiment of the shopping cart handle cover showing an attachment receiver on the collar, according to an aspect of the disclosure.

FIG. 8 is a perspective view of still another embodiment of the shopping cart handle cover having a variation of design on the collars, according to an aspect of the disclosure.

FIG. 9 is a left side view of the shopping cart handle cover of FIG. 8, according to an aspect of the disclosure. The right side being a mirror image thereof.

FIG. 10 is a front view of the shopping cart handle cover of FIG. 8, according to an aspect of the disclosure.

FIG. 11 is a rear side view of the shopping cart handle cover of FIG. 8, according to an aspect of the disclosure.

FIG. 12 is a cross-sectional view a body of the shopping cart handle cover along line D-D of FIG. 9, according to an aspect of the disclosure.

FIG. 13 is a top view of the shopping cart handle cover showing the collar of FIG. 8, according to an aspect of the disclosure.

FIG. 14 is a perspective view of still yet another embodiment of the shopping cart handle cover having a variation of design on the elongated body, according to an aspect of the disclosure.

FIG. 15 is a perspective view of one embodiment of the shopping cart handle cover having a shorter body and having collars of different outer diameters, according to an aspect of the disclosure.

FIG. 16 is a perspective view of still another embodiment of the shopping cart handle cover having a cut line the elongated body, according to an aspect of the disclosure.

FIG. 17 is a cross-sectional view of an elongated body of yet another embodiment of the shopping cart handle cover, according to an aspect of the disclosure.

FIG. 18 illustrates a connector tethered to the open notch of a collar, according to an aspect of the disclosure.

The following call-out list of elements in the drawing can be a useful guide when referencing the elements of the drawing figures:

| | | | |
|---|---|---|---|
| 5 | Handlebar | 300 | Handle Cover |
| 100 | Handle Cover | 302 | Elongated Body |
| 102 | Elongated Body | 303 | Wall |
| 103 | Wall | 304 | Center Bore |
| 104 | Center Bore | 306 | Body Slit |
| 106 | Body Slit | 310 | Collar |
| 110 | Collar | 315 | Collar Rim |
| 111 | Outer Side | 317 | Center Opening |
| 112 | Collar Slit | 325 | Open Notch |
| 113 | Inner Side | 341 | Grasping Tab |
| 114 | Hole | 345 | Receiving Slope |
| 115 | Collar Rim | 400 | Handle Cover |
| 116 | Catch | 406 | Body Slit |
| 117 | Center Opening | 450 | Fin |
| 118 | Circular Cut Out/Catch | 454 | Rib |
| 170 | Finger Tab | 502 | Elongated Body |
| 200 | Handle Cover | 506 | Body Slit |
| 202 | Body | 510 | Collar |
| 210 | Collar | 512 | Collar Slit |
| 212 | Collar Slit | 602 | Elongated Body |
| 215 | Collar Rim | 606 | Body Slit |
| 217 | Center Opening | 660 | Cutting Line |
| 225 | Open Notch | A-A | Terminal End Diameter |
| 226 | Notch Width | B-B | Mid-Section Diameter |
| 230 | Gap Width | C-C | Terminal End Diameter |
| 235 | Receiver | D-D | Terminal End Diameter |
| 236 | Connector | E-E | Mid-Section Diameter |
| | | F-F | Terminal End Diameter |

### DETAILED DESCRIPTION OF THE EMBODIMENTS

The different aspects of the various embodiments can now be better understood by turning to the following detailed description of the embodiments, which are presented as illustrated examples of the embodiments as defined in the claims. It is expressly understood that the embodiments as defined by the claims may be broader than the illustrated embodiments described below.

The inventor has designed a novel device to universally fit over any public shopping cart handle 5 (see FIG. 13) or door handlebar 5.

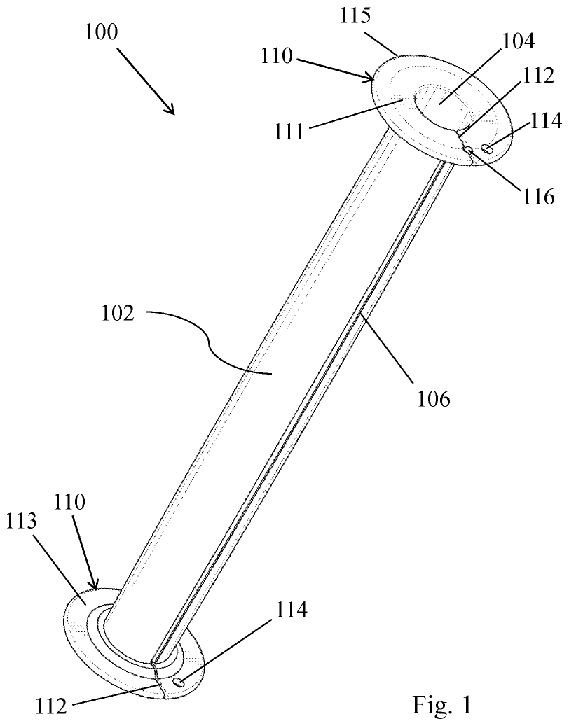

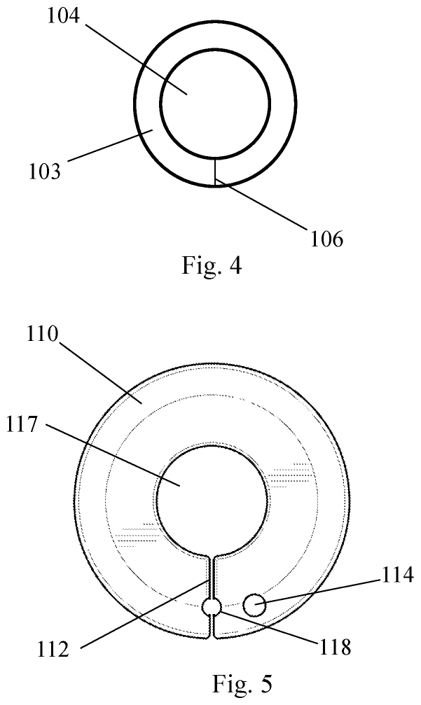

Referring now to FIG. 1, a handle cover 100 has an elongated body 102 made of any acceptable material. In one contemplated embodiment, the material can be pliable and soft. The elongated body has a body slit 106 that runs along the entire length of the elongated body and cuts through the entire thickness of the wall 103 (see FIG. 4) of the elongated body. The body slit 106 generally has an equal gap width along the entire length of the body lit 106, but the disclosure is not limited thereto.

In one aspect of the embodiment, the elongated body 102 is hollow with a center bore 104 (see FIG. 4) through the entire length of the elongated body. The center bore 104 is shown to have a circular cross-sectional shape, but the disclosure is not limited thereto. Other cross-sectional shapes are contemplated to provide various degrees of friction onto the shopping cart handle.

On either terminal end of the elongated body 102 there can be provide a collar 110. In the embodiment shown in FIG. 1, the collar 110 has a disc shape and the collar can have a collar slit 112. The outer side 111 of the collar 110 can be flat, but the disclosure is not limited thereto. The collar 110 can have a circular rim 115 but the disclosure is not limited thereto. The collar rim 115 can have other geometric shapes.

The collar slit 112 spans through one side of the collar 110 and directly connects to the body slit 106. In this way, the body slit 106 and the two collar slits 112 are combined to create one slit opening adapted to receive a shopping cart handle 5 (see FIG. 13).

The inner side 113 of the collar 110 can have a flat shape and can be angled at 90 degrees to the longitudinal axis of the elongated body 102. The inner side 113, however, can have other shapes and contours that are angled anywhere from 45 to 90 degrees to the longitudinal axis of the elongated body 102. The collars 110 can guide a user's hand to stay within the area between the two collars 110.

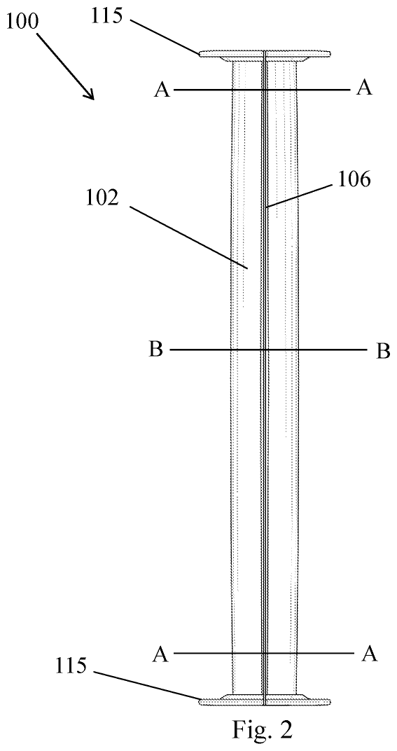

In FIG. 2, a front view of one embodiment of the handle cover 100 is shown. Here, the mid-section B-B of the elongated body 102 has an outer diameter slighter larger than the outer diameter of the two terminal sections A-A. This design can allow easier bending of the elongated body 102 during installation and removal of the handle cover 100 to and from the shopping cart handle. In this view, the rim 115 of the collars 110 are shown to be wider than the diameter of the elongated body 102.

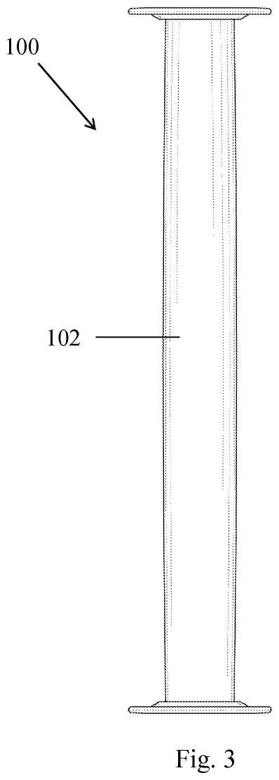

Referring now to FIG. 3, a rear side of the contemplated handle cover 100 has no body slits 106. The left side view and the right-side view has exact view of the rear side view in this particular embodiment.

FIG. 4 shows the cross-sectional view of the elongated body 102 along line A-A or B-B of FIG. 2. Body slit 106 is shown here being very thin and tight, but the disclosure is not limited thereto. The body slit 106 can alternatively have a wider gap. The wall 103 of the elongated body 103 can be solid in some embodiments. In other embodiments, the wall 103 of the elongated body 103 can be perforated or porous, depending on the material used (e.g., foam).

The contemplated designs can accommodate varying diameters of shopping cart handles. The center bore 104 may be sufficiently large to allow for a larger diameter shopping cart handle, and still function and provide the same protection for smaller diameter shopping cart handles. Conversely, the center bore 104 may be small but would still partially envelop a larger diameter shopping cart handle, and still function and provide the same protection.

When looking at the collar 110 from top, FIG. 5 shows one embodiment where the collar 110 can have a through hole 114 allowing a strap or a parachute cord to be attached thereto. The strap can be used as a wristlet. In another embodiment, a longer strap can be attached on either end to the two collars 110 via the through holes 114 on these collars 110. In this way, the longer strap can be used as shoulder straps so the user may carry the handle cover 100 across his/her chest or back.

On the collar slit 112 there can be provided a circular cut out 118 forming a catch. A user may use this circular cut out 118 to tuck the strap out of the way when the handle cover 100 is installed onto the shopping cart handle. While the circular cut out 118 is shown in a circular shape, the disclosure is not limited thereof. Other geometric shapes are also contemplated.

Referring now to FIG. 5, the collar 210 can have a collar slit 212 wherein the gap width 230 of the collar slit 212 is wider towards the rim 215 of the collar 210, and relatively narrower towards the center opening 217 of the collar 210. The collar slit 212 can have a flaring out such that the edge of the collar slit 212 can have an arcuate shape. This flaring out can ease the entry of a shopping cart handle. In other words, this can substantially make it easier for a user to snap the collar 210 over a shopping cart handle or push the collar 210 onto the shopping cart handle. In operation, a user can install a handle cover 200 by first holding the handle cover 200 at an angle to the shopping cart handle, allowing the collar slit 212 to make the initial engagement with the shopping cart handle. Once the shopping cart handle passes through the collar slit 210 and the center opening 217 wraps around the shopping cart handle, the user may next press the rest of the handle cover 200 over the shopping cart handle, eventually enveloping the shopping cart handle.

Alternatively, collar slits 212 can have a radius or be tapered to a center point radius so there is less surface friction coming in contact with the shopping cart handle.

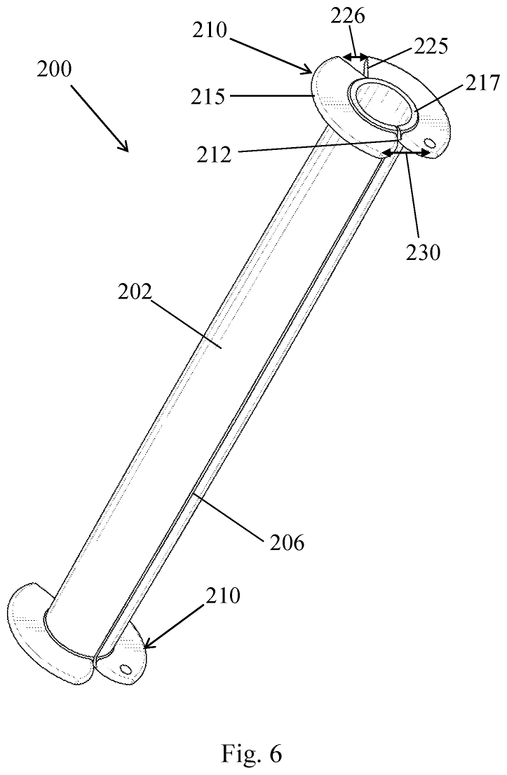

Optionally, there can be provide an open notch 225 on the collar 210. The open notch 225 can be disposed on the opposite side of the collar slit 212, but the disclosure is not limited thereto. The open notch 225 is a gap in the collar 210. FIG. 6 shows this gap having a pie shape, but the disclosure is not limited thereto. Other shapes are also contemplated. This gap is represented as a notch width 226 and can be varied. In the example shown in FIG. 6, the notch width 226 is narrower when it is closer to the center opening 217 and wider when it is further away from the center opening 217. When the collar slit 212 is parted to receive a shopping cart handle, the open notch 225 can prevent or minimize the collar 210 from distorting out of plane. In other words, the open notch 210 provides sufficient room for the two arcuate pieces that make up a collar 210 to move, thereby closing the notch width 226.

Again, the open notch 210 allows the collar 210 to flexes like a hinge, allowing the opposite edges of the open notch 210 to come closer together as the collar slit 212 opens as the user pushes the collar slit 212 onto the shopping cart handle. Once the collar 210 and collar slit 212 move 50% over the shopping cart handle and since the handle cover is circular or semi-circular, the handle cover 200 then easily slips over the shopping cart handle. The user can push one collar 210 onto the handle and then apply light or moderate pressure in the mid-section of the elongated body 202 straight down onto the shopping cart handle to install the shopping cart handle cover 200.

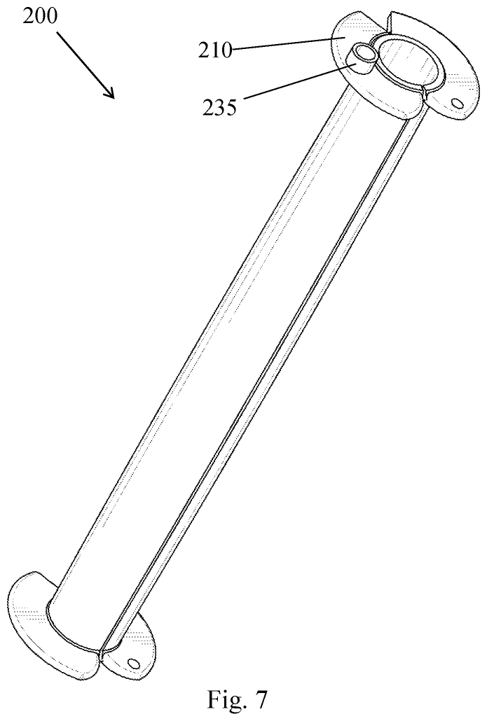

In FIG. 7, a receiver 235 can be provided on the collar 210. The receiver 235 is shown to have a generally tubular shape, but the disclosure is not limited thereto. This tubular structure can have a bottom, or it can be bottomless such that its center space allows an item to pass through the thickness of the collar 210. The receiver 235 can be used to attach many kinds of accessories, such as keys, a hanging hook, and other novelty items.

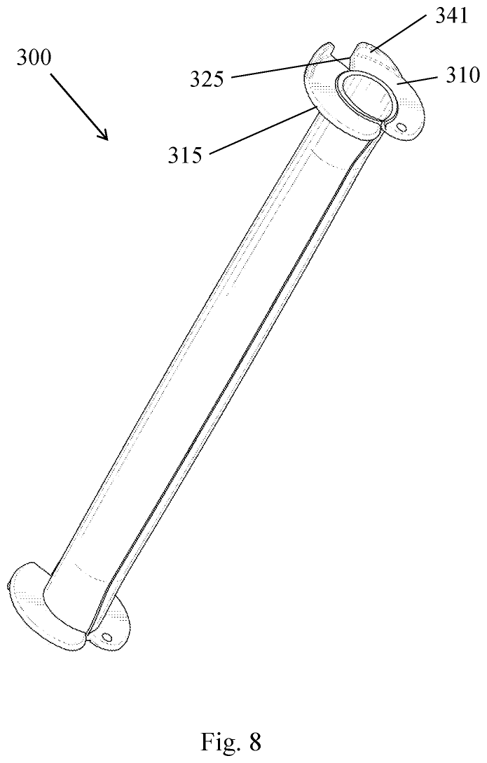

Referring now to FIG. 8, here two grasping tabs 341 are provided on a collar rim 315. These grasping tabs 341 can be positioned on either side of the open notch 325 allowing a user to pitch them together with a thumb and an index finger. Each grasping tab 341 can have a plane perpendicular to the plane of the collar 310. In one design, the grasping tab 341 can have a similar thickness to the collar 310.

These grasping tabs 341 can also allow the user to directly pull the collar 310 away from the shopping cart handle, actuating the hinge to open the collar slit 312.

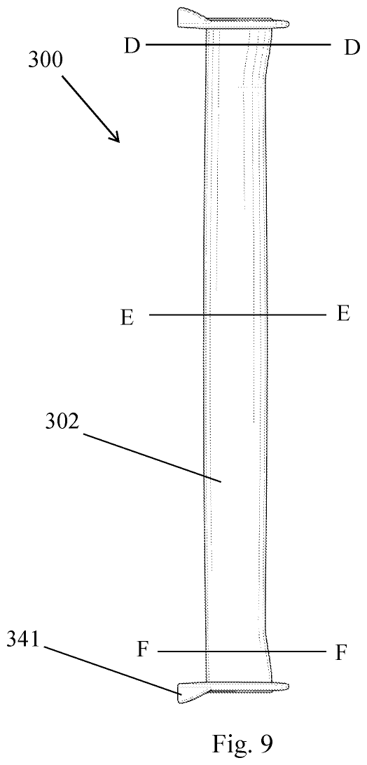

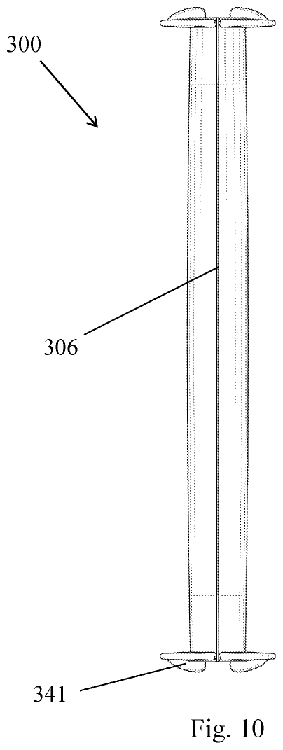

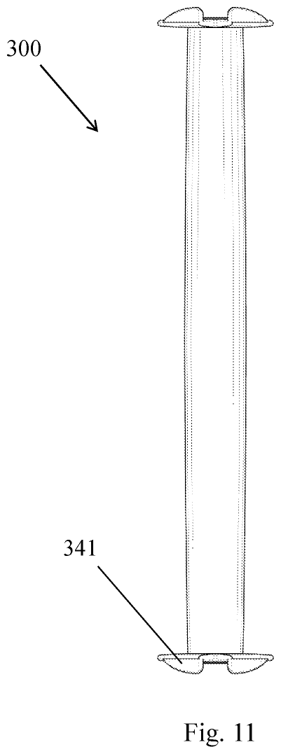

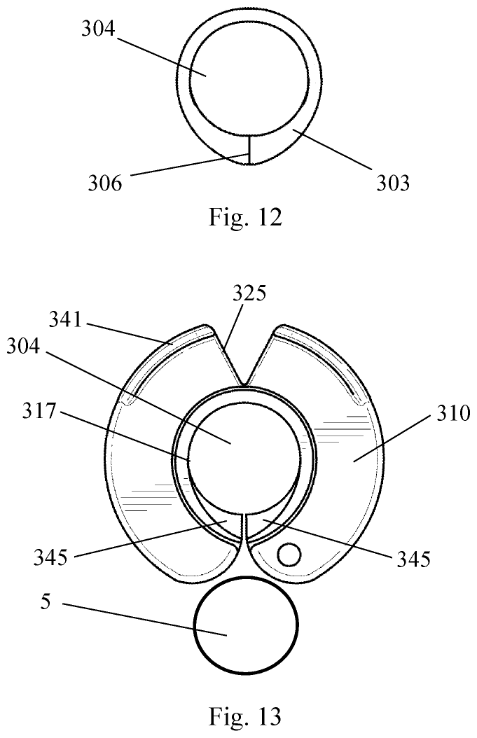

As described earlier, the elongated body can have varied diameter. In FIGS. 8-13, a particular embodiment is shown where the elongated body 302 of handle cover 300 can have varied cross-sectional shapes in different portions of the elongated body 302. FIG. 12 shows the cross-sectional shape of the elongated body 302 along lines D-D and F-F of FIG. 9. This cross-sectional shape shows an outer teardrop contour while the center bore remains circular. The cross-sectional shape of the elongated body 302 along lines E-E is circular (see FIG. 4).

In one specific embodiment, the teardrop cross-sectional shape is throughout the entire length of the elongated body 302.

In FIG. 13, a pair of receiving slopes 345 is contemplated in this embodiment. These receiving slopes 345 provide a concaving structure having that portion of collar 310 along the center opening 317 to have decreasing thickness toward the center. The receiving slopes 325 help ease the entry of shopping cart handle 5. The receiving slopes 325 are structurally supported by the tapering end of the teardrop cross-sectional shape, to help the body slit 306 from enveloping itself when forced upon the shopping cart handle 5.

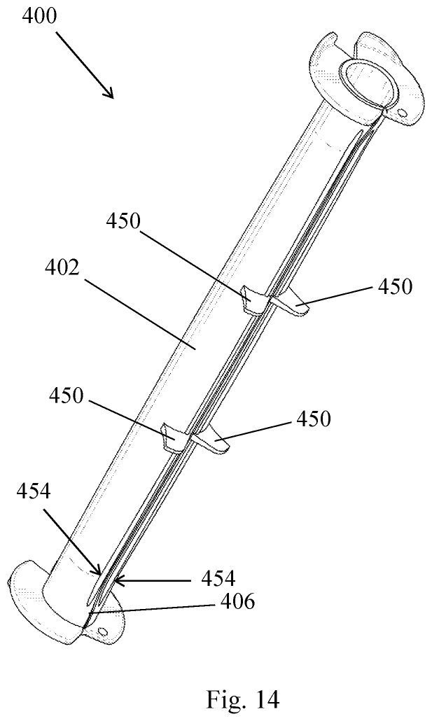

Referring now to FIG. 14, there can be provided fins 450 on the elongated body 402 of handle cover 400. The fin 450 can be a flat protruding piece perpendicular to the surface of the elongated body 402. The fin 450 can be shaped and contoured to provide a receiving openings between the pair of fins 450 thereby guiding a shopping cart handle to slide therethrough and helps the body slit to open smoothly. In one embodiment, a pair of such fins 450 can be disposed on opposing sides of the body slit 406.

Also optionally provided is a rib 454 that runs along the entire length of the body slit 406. Here in FIG. 14, the rib 454 is a raise stripe that can provide structure integrity to the edges of the body slit 406. In this way, the edges of the body slit 406 is reinforced and prevented from enveloping itself when the body slit 406 is abutted against the shopping cart handle.

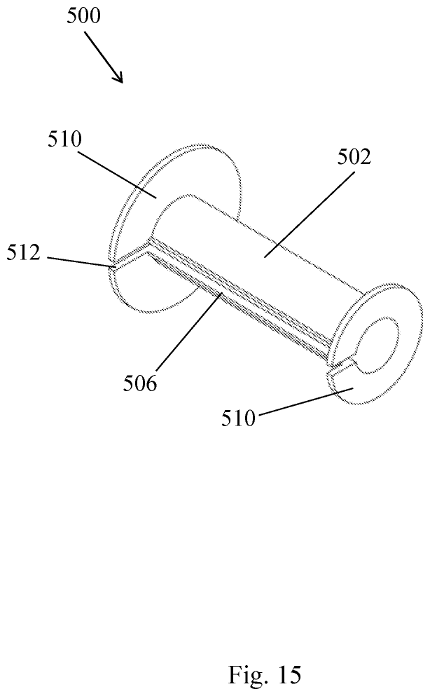

As those of ordinary skill in the art will recognize, the handle cover 100, 200, 300, 400 can also come in shorter length. FIG. 15 shows one embodiment of a shorten version of handle cover 500. Here, handle cover 500 can have a body 502 with a body slit 506. The body slit 506 is connected to collar slits 512 of both collars 510 which are connected to the two terminal ends of the body 502. As is true with any other embodiments disclosed herein, the two collars 510 of a handle cover can have different diameter. Here in FIG. 15, one diameter is noticeably larger than the other.

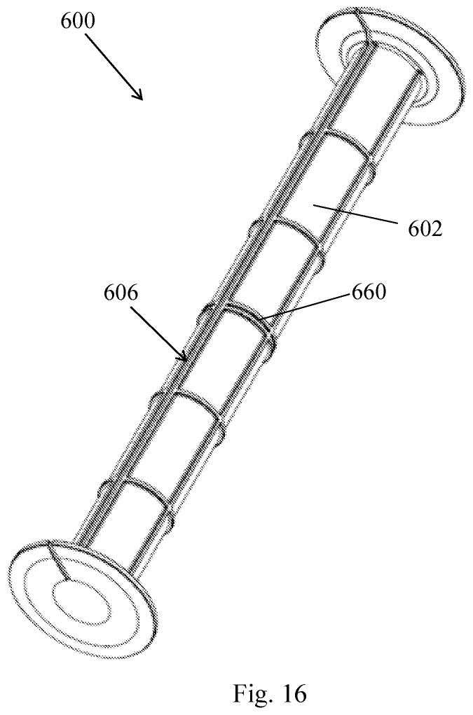

In FIG. 16, an embodiment is contemplated to have a cutting line 660 disposed transversely in the mid-section of the elongated body 602. The cutting line 660 can be a perforated line or a thinned-out portion of the elongated body 602 allowing a user to easily cut, sever, or tear apart the elongated body 602 into two separate pieces. By doing so, the user would effectively create two shorter pieces of handle cover 600.

Although the above embodiments disclose various ways to pinch or pull open the body slit 106 using, grasping tabs 341, etc., other types of structures can also be used to perform that same function to force open the body slit 106.

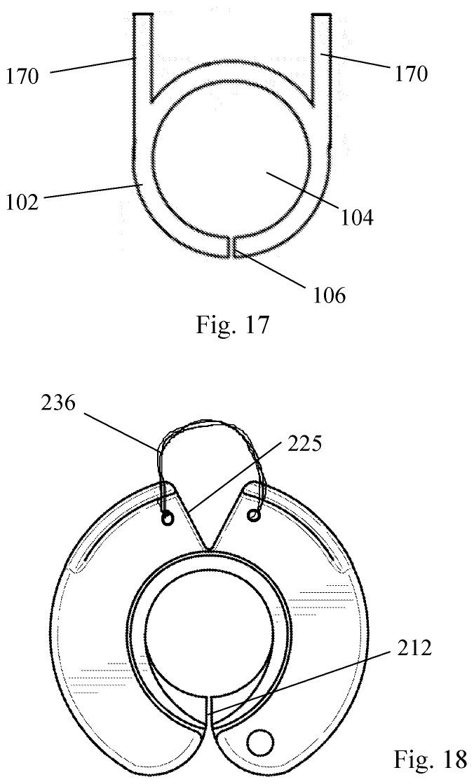

As illustrated in FIG. 17, there can be provided a pair of rigid or semi-rigid finger tab 170 anywhere on the elongated body 102. By pinching the two finger tabs 170 towards each other, the body slit 106 is forced to open wider.

In FIG. 18, there can be contemplated a connector 236 tethered to the opposing edges of the open notch 225. This connector can be of any material, such as a rope, a short stripe, a longer rope, or a plastic bridge molded from the same material as the collar 210. This connector 236 can function as a handle thereby allowing a user to pull up on it causing the opposing edges of the open notch 225 to come together. In this way, the collar slit 212 opens allowing the user to easily pull handle cover 200 off the shopping cart handle.

The contemplated elongated body 102 and collars 110 can be made of suitable materials, such materials include natural and synthetic polymers, naturally occurring materials, textile fibers, and all reasonable combinations thereof. In some embodiments, the elongated body 102 can be made of a material different from the collars 110. In some other embodiments, the elongated body 102 can have a hardness different from the collars 110. The material used could be rigid or flexible, incorporating excellent flex fatigue resistance.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of shopping cart handle cover have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

What is claimed is:

1. A reusable universal shopping cart handle cover to provide a sanitary barrier between a user and a shopping cart handle, comprising:
an elongated body having a body slit opening disposed on the elongated body in a longitudinal direction along an entire length of the elongated body;
a first collar directly connected to a first terminal end of the elongated body;
a second collar directly connected on a second terminal end of the elongated body;
said first and second collars each having a collar rim, the collar rim having an outer diameter larger than a diameter of said first and second terminal ends of the elongated body;
said first and second collars each having a collar slit directly connected to the body slit;
wherein the elongated body has a has a hollow interior having a center bore through the entire length of the elongated body, and the center bore is surrounded by a wall of the elongated body;
wherein the wall has a circular cross-sectional shape;
wherein the body slit is disposed through a thickness of the wall;
wherein the first and second collar each has a center opening directly connected to the center bore.

2. The reusable handle cover as recited in claim 1, wherein the collar slit of at least one of said first and second collars has a gap width, and the gap width closer to the center opening is narrower than the gap width near the collar rim.

3. The reusable handle cover as recited in claim 2 further comprising an open notch having a notch width, the open notch is disposed on at least one of said first and second collars opposite to the collar slit, and the notch width closer to the center opening is narrower than the notch width near the collar rim.

4. The reusable handle cover as recited in claim 1, wherein the terminal end of the body has a teardrop cross-sectional shape that is globular on one end and tapers to a point on an opposite end.

5. The reusable handle cover as recited in claim 4, wherein the mid-section of the body has a circular cross-sectional shape.

6. The reusable handle cover as recited in claim 1 further comprising at least one grasping tab disposed on at least one of said first and second collars; said grasping tab protrudes from a plane of the respective at least one of said first and second collars.

7. The reusable handle cover as recited in claim 6 further comprising a pair of receiving slopes disposed on at least one of said first and second collars; the pair of receiving slopes are disposed on opposite side of the collar slit approximate to the center opening.

8. The reusable handle cover as recited in claim 1 further comprising at pair of fins disposed on the body; said pair of fins are disposed on opposite sides of the body slit and each has a plane perpendicular to a longitudinal axis of the elongated body.

9. The reusable handle cover as recited in claim 1 further comprising a pair of fins disposed along the entire length of the body and on opposite sides of the body slit; said fins protrudes from the body.

10. The reusable handle cover as recited in claim 9 further comprising a cutting line transversely disposed on the body; said cutting line guides a user to sever the elongated body.

11. The reusable handle cover as recited in claim 9, where the diameter of the first and second terminal ends is smaller than a diameter of a mid-section of the elongated body.

12. The reusable handle cover as recited in claim 9 further comprising a through hole on at least one of said first and second collars.

13. The reusable handle cover as recited in claim 12 further comprising a circular cut out on the collar slit of at least one of said first and second collars.

14. The reusable handle cover as recited in claim 13, wherein said first and second collars each has a disc shape.

15. The reusable handle cover as recited in claim 12 further comprising a receiver disposed on at least one of said first and second collars; said receiver is adapted to receive an accessory.

16. The reusable handle cover as recited in claim 1 further comprising a pair of finger tabs disposed on the body wherein pressing the pair of finger tabs towards each other causes the body slit to open.

17. The reusable handle cover as recited in claim 3 further comprising a connector tethered to opposing edges of the open notch.
